(19) United States
(12) Patent Application Publication
(10) Pub. No.: US 2008/0003092 A1
(43) Pub. Date: Jan. 3, 2008

(54) Rotary union connection

(76) Inventors: Petar Baclija, Etobicoke (CA); Andre Weclawski, Mississauga (CA)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/477,466

(22) Filed: Jun. 30, 2006

(51) Int. Cl. B65G 1/133

(52) U.S. Cl. 414/752.1

(57) ABSTRACT

A rotary union connector is disclosed that may be used with a robot arm having a drive member. The connector may have an outer housing and an inner cylinder. The inner cylinder may be fixedly mounted to the drive member for rotation about a central longitudinal axis. The inner cylinder may be mounted for rotation within and relative to the outer housing. The inner cylinder may have a first vacuum channel, and may be adapted to be fixedly mounted to an end effector. The outer housing may have a first vacuum channel and a first vacuum opening for connection to a vacuum supply line to supply vacuum to the first vacuum channel in the outer housing. The vacuum channel in the outer housing may also be in vacuum communication with the first vacuum channel in the inner cylinder. The first vacuum channel in the inner cylinder has an opening for communicating vacuum from the opening to the at least one suction cup of the pick up member. When the drive member is rotated, the inner cylinder and end effector will rotate about the axis with the outer housing remaining substantially stationary in rotational movement.

### FIELD OF THE INVENTION

The present invention relates to a rotary union connection that connects an end effector to an arm.

### BACKGROUND OF THE INVENTION

Robots are used in many different applications and fields, including the packaging industry. Robots may have an articulated arm connected to a base with one or more arm sections connected by one or more joints. At each joint, adjacent arm sections may be able to pivot relative to each other. Each such joint may permit rotation about one or possibly more axes.

A distal arm section of a robotic arm may have an end effector attached proximate its distal end. The end effector may also be able to rotate about various axes, such as being able to rotate about a longitudinal axis that passes generally in parallel alignment with the longitudinal axis of the distal arm section.

End effectors mounted on robot arms can be used for a variety of applications. However, in the packaging industry there have been limitations in the use of robots. This is due in part to the difficulties associated with interconnecting an end effector to an arm section of the robotic arm, in such a manner that the end effector is not unduly restricted in its movement relative to the end arm section.

In the packaging industry, it is often desired to pick up one or more items such as for example, a product or a container, with a moving device that may employ a plurality of pick up members, each pick up member having one or more suction cups. To pick up an item, one or more suction cups which are generating a vacuum air flow towards the cup, come into contact with the surface of an item. The maintenance of a vacuum applied to the suction cups will hold the item on the device. It should be noted that in this document the term “vacuum” refers to the air (or other gas”) being at a pressure below atmospheric pressure or below other environmental pressure. With the item being held by the suction cup(s), the item moving device will then move the item from one location to another second location. At the second location it is desired for the moving device to release the item. To release the item, the vacuum being generated at the suction cups is released. Sometimes it is desired to be able to adjust the pitch between adjacent items held by adjacent pick up members.

A vacuum air flow may be supplied to each of the suction cups of the pick-up members through vacuum supply lines. The vacuum source may be located at, or proximate to, the robot or elsewhere. To be able to develop a vacuum flow of air at multiple suction cups, a significant amount of vacuum flow will have to be communicated.

If it is desired to use a robot with a robot arm having an end effector in the packaging industry, the end effector may have to be able to rotate relative to the last arm section. For example, it may be required to rotate about a longitudinal axis of the last arm section and a transverse axis, which is orthogonal to the longitudinal axis. However, it will then also be desirable in such applications that the vacuum be communicated from the vacuum supply to the suction cups on the end effector in some manner.

These vacuum supply lines could be passed either inside or outside of a joint connecting articulated arm sections. Likewise, the vacuum supply lines could be passed either inside or outside of the joint connecting the end effector and robotic arm. However, certain rotational movements of the end effector may be restricted by the vacuum supply lines, in particular, if the lines are passed inside the joint for a number of reasons. For example, rotation of the joint may place strain on the supply lines. Rotation of the joint may similarly be restricted if the vacuum supply lines are passed outside the joint.

Additionally, a major difficulty with communicating a vacuum to an end effector that includes a plurality of suction cups, is that the channels for communicating the vacuum to each of the suction cups are typically required to have a relatively large cross sectional area. This is because it is relatively difficult in a typical industrial environment to generate a vacuum flow that is highly negative in pressure (it is easier to generate high positive pressure air to provide pressurized air). Therefore, to provide sufficient vacuum for a plurality of suction cups, a much larger cross section area in the vacuum supply hoses is typically required.

As mentioned, it may also be desirable to adjust the pitch between adjacent items held by adjacent pick up members, by adjusting the pitch of the pick up members themselves that are on the end effector. It is known to use one or more pneumatic or hydraulic cylinders to activate a mechanism to adjust the position of the pick up members. These cylinders need to be supplied by pressurized air or hydraulic fluid.

Thus, to further complicate the delivery of vacuum to suction cups of an end effector carried by a robotic arm, there may also be is a need to accommodate multiple vacuum lines, as well as one or more pressurized air supply lines, without unduly restricting rotational movement of the end effector.

### SUMMARY OF THE INVENTION

According to one aspect of the invention there is provided a rotary union connector for use with a robot arm, the robot arm having a drive member mounted to an arm section for rotation of the drive member relative to the arm section about an axis; the connector comprising: (a) an outer housing; (b) an inner cylinder fixedly mounted proximate a first end to the drive member and for rotation with the drive member arm about a central longitudinal axis of the inner cylinder that is aligned with the axis, the inner cylinder being mounted for rotation within and relative to the outer housing; the inner cylinder having a first vacuum manifold with a first vacuum channel, and the inner cylinder being adapted to be fixedly mounted proximate a second end opposite to the first end, to an end effector, the end effector having a plurality of pick up members each having at least one suction cup; the outer housing being disposed between the first and second ends of the inner cylinder and the outer housing comprising a first vacuum chamber having a first vacuum channel, and a vacuum opening for connection to a vacuum supply line to supply vacuum to the first vacuum channel in the vacuum chamber, the first vacuum channel of the vacuum chamber also being in continuous vacuum communication with the first vacuum channel of the vacuum manifold; the first vacuum channel in the vacuum manifold having an opening for communicating vacuum from the opening to the at least one suction cup of the plurality of pick up members; wherein when the drive member is rotated about the axis, the inner cylinder and the end effector will also rotate about the axis, with the outer housing remaining substantially stationary in rotational movement about the axis.

According to another aspect of the invention there is provided a robot comprising: (a) a base; (b) an articulated arm comprising a plurality of arm sections, the arm sections comprising a distal arm section; (c) a drive member mounted to the arm section and operable to rotate the drive member relative to the distal arm section about an axis; (d) an end effector comprising a pick up member with a suction cup; (e) a rotary union connector disposed between the drive member and the end effector, the connector comprising: i. an outer housing; ii. an inner cylinder fixedly mounted proximate a first end to the drive member for rotation with the drive member about a central longitudinal axis of the inner cylinder that is aligned with the axis, the inner cylinder being mounted for rotation within and relative to the outer housing; iii. the inner cylinder having a first vacuum channel, and the inner cylinder being adapted to be fixedly mounted proximate a second end opposite to the first end, to the end effector; iv. the outer housing being disposed between the first and second ends of the inner cylinder and the outer housing comprising a first vacuum channel and a vacuum opening for connection to a vacuum supply line to supply vacuum to the first vacuum channel, the first vacuum channel also being in continuous vacuum communication with the first vacuum channel in the inner cylinder; v. the first vacuum channel having an opening for communicating vacuum from the opening to the suction cup; wherein when the drive member is rotated about the axis, the inner cylinder and the end effector will also rotate about the axis, with the outer housing remaining substantially stationary in rotational movement about the axis.

According to a further aspect of the invention there is provided a rotary union connector for use with a robot arm, the robot arm having a drive member mounted for rotation, the connector comprises: (a) an outer housing; (b) an inner cylinder fixedly mounted proximate a first end for rotation with the drive member for rotation of the inner cylinder about a central longitudinal axis of the inner cylinder, the inner cylinder being mounted for rotation within and relative to the outer housing; the inner cylinder having a first vacuum channel, and the inner cylinder being adapted to be fixedly mounted to an end effector, the end effector having a pick up member having at least one suction cup; the outer housing comprising a first vacuum channel and a first vacuum opening for connection to a vacuum supply line to supply vacuum to the first vacuum channel in the outer housing, the vacuum channel in the outer housing also being in vacuum communication with the first vacuum channel in the inner cylinder; the first vacuum channel in the inner cylinder having an opening for communicating vacuum from the opening to the at least one suction cup of the pick up member; wherein when the drive member is rotated, the inner cylinder and the end effector will rotate about the axis, with the outer housing remaining substantially stationary in rotational movement about the axis.

### BRIEF DESCRIPTION OF THE DRAWINGS

In drawings illustrating by way of example only, embodiments of the invention:

FIG. 1A is a right side perspective view of a robot with a rotary union connector disposed between an end effector and a robotic arm.

FIG. 1B is a left side perspective view of the robot of FIG. 1A.

FIG. 2 is an enlarged isolated front perspective view of the rotary union connector attached to an end-effector, as shown in FIGS. 1A and 1B

FIG. 3 is a side perspective view of the rotary union connector of FIG. 2, shown in isolation.

FIG. 4 is a back elevation view of the connector of FIG. 3

FIG. 5 is a side elevation view of the connector of FIG. 3.

FIG. 6 is a top plan view of the connector of FIG. 3.

FIG. 7 is a bottom plan view of the connector of FIG. 3

FIG. 8 is a bottom perspective view of the connector of FIG. 3, with a bottom end effector mounting plate removed.

FIG. 9 is a cross sectional view at 9-9 in FIG. 4.

FIG. 10 is a cross sectional view at 10-10 in FIG. 5.

FIG. 11 is a semi-transparent of part the rotary union connector and part of the end effector of FIG. 2.

FIG. 12 is a semi-transparent perspective view of part of the rotary union connector of FIG. 2.

FIG. 13 is a cross section taken in the region of plane portion 13 in FIG. 11.

### DETAILED DESCRIPTION

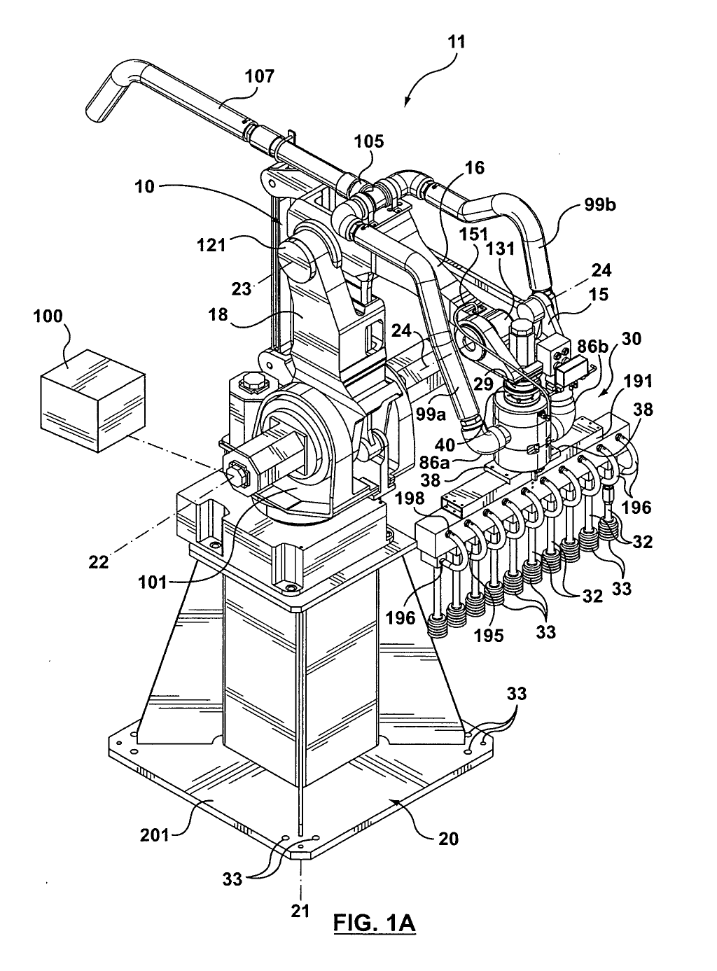

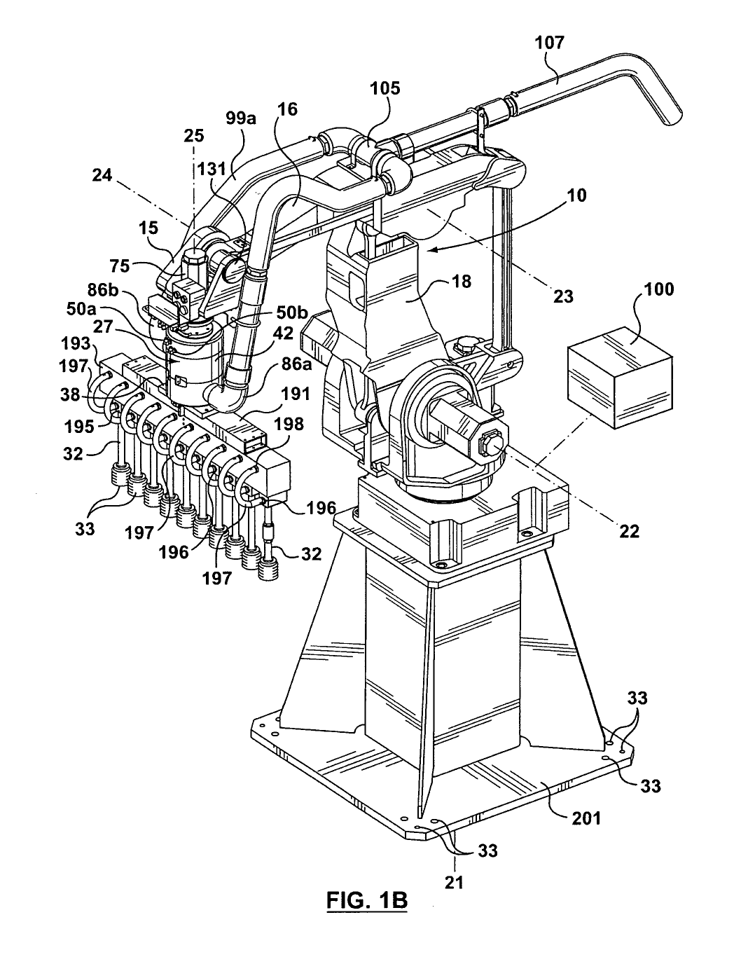

With reference to FIGS. 1A and 1B, a rotary union union connector generally designated as 27, is shown connected to a robotic arm 10 of a robot generally designated 11. Robot 11 may be any suitable robot. For example, robot 11 may be a 4-axis robot such as, for example, the robot system which is made by Fanuc Robotics. The robot system may be the model M-420iA robot system made by Fanuc Robotics and which may be supplied with a system controller designated schematically as controller 100. The movement of robot 11 and its arm sections 15, 16 and 18 can be controlled by the robotic system controller 100.

Robot 11 has a base 20 which can be securely connected to, or mounted on, for example, a frame or on a building floor with bolts (not shown) passing through bolt holes 33 in a base plate 201 and secured into the frame or floor.

Robotic arm 10 has a series of articulated arms sections that include a first arm section 18, a second arm section 16, and a third arm section 15. Robotic arm 10 may rotate at several pivoting connection or joint locations about a plurality of axes. In the embodiment illustrated in FIGS. 1A and 1B, robot arm section 18 is mounted to base 20 with a joint connection 101 and can rotate relative to base 20 (which may be fixed relative to the environment) about an axis 21, which may be vertically oriented. Arm section 18 and joint connection 101 can also may be configured to rotate arm section 18 relative to base 20 about an axis 22, which may be orthogonal to axis 21 and axis 22 may be horizontally oriented.

Robot arm section 16 and arm section 18 may rotate relative to each other at a joint connection 121, about an axis 23. Third arm section 15 may be connected to arm section 16 at a joint connector 131 and these arm sections 15 and 16 may be configured to rotate relative to each other about an axis 24.

Third arm section 15 may have fixedly secured thereto a drive motor 75. Drive motor 75 may have a drive plate 29, which may be configured to rotate about an axis 25. Drive plate 29 may also be configured such that the mounting plate 40 of the rotary union connector 27 can be fixedly mounted thereto.

End effector 30 may be mounted to arm section 15 by having rotary union connector 27 disposed therebetween. The mounting plate 38 of rotary union connector 27 may be fixedly secured to hollow mounting block 191 of end effector 30 using bolts (not shown) which pass through holes 122a-d of plate 38 into mounting block 191.

The rotary union connector 27 has an outer housing 42 which is adapted for interconnection to vacuum supply lines 99a, 99b, with vacuum connectors 86a, 86b respectively. Vacuum supply lines 99a, 99b may have internal diameters of in the range of order of about 2.5 inches, although other sizes are contemplated. Vacuum supply lines 99a, 99b join at a T-junction 105 to main vacuum line 107, which is connected to a vacuum source (not shown). The vacuum supply lines typically may carry air having pressures in the range of about negative 100 inches of water.

In addition to handling the communication of vacuum the end effect to provide a suction air flow at the suction cups, rotary union connector 27 may also transmit pressurized air from pressurized air supply lines 151. Pressurized air is communicated from air lines 151 which may pass through or along the arm sections in known ways to arm section 15 where air lines may be interconnected to pressurized air inlets 50a, 50b. The air pressure in the air lines 151 may be in the order of about 80 psi. From air inlets 50a, 50b, two pressurized air channel flows are communicated to the end effector through rotary union connector 27, as described further hereafter.

With reference now to FIGS. 1A. 1B and 2, end effector 30 may include mounting block 191, a pick up member manifold 193, and a plurality of pick up member hollow support blocks 195. Each support block 195 may have an interior air chamber and support and be in vacuum communication with one or more pick up members 32 having one or more suction cups 33. Mounting block 191 may be divided into two separate internal chambers and each chamber can supply vacuum to a respective separate chamber in manifold 193. Tubes 197 may interconnect opening 196 in manifold 193 with openings 196 in blocks 195. Each one of the pick up members 32 may be communication with one of the interior chambers in block 195.

Thus, a vacuum can be generated at each of the suction cups 33 on the pick up members by: communication of a vacuum flow from the suction cups 33 to each respective support block 195; then the vacuum flow may be communicated in separate flow paths from support blocks 195 through connecting tubes 197 into manifold 193. The vacuum manifold 193 may combine the separate vacuum flow paths from each of the support blocks 195 into two main vacuum flow paths. Each one of these two main vacuum flow paths may then be communicated to one of the two interior chambers in block 191, where the flow paths are then communicated to an inlet 70a, 70b, of one of the vacuum channels in the cylinder 35, as described below.

While a pitch adjusting mechanism is not for simplicity shown in the drawings, each pick up member 32 can move in such a manner that the pitch between adjacent suction cups can be varied. Various pitch-adjusting mechanisms are known in the art. A few examples of such mechanisms are disclosed in US Patent publication no. 2003/0235491 filed by Milos Misha Subotincic on Apr. 22, 2003 under application Ser. No. 10/420,075, the entire contents of which are hereby incorporated herein by reference.

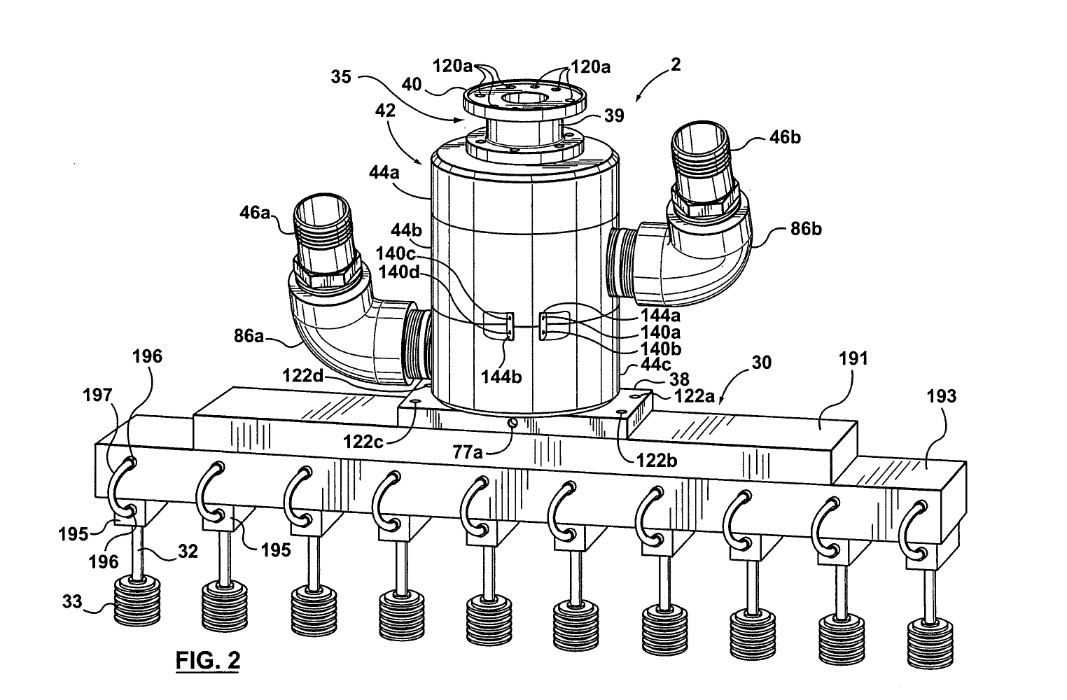

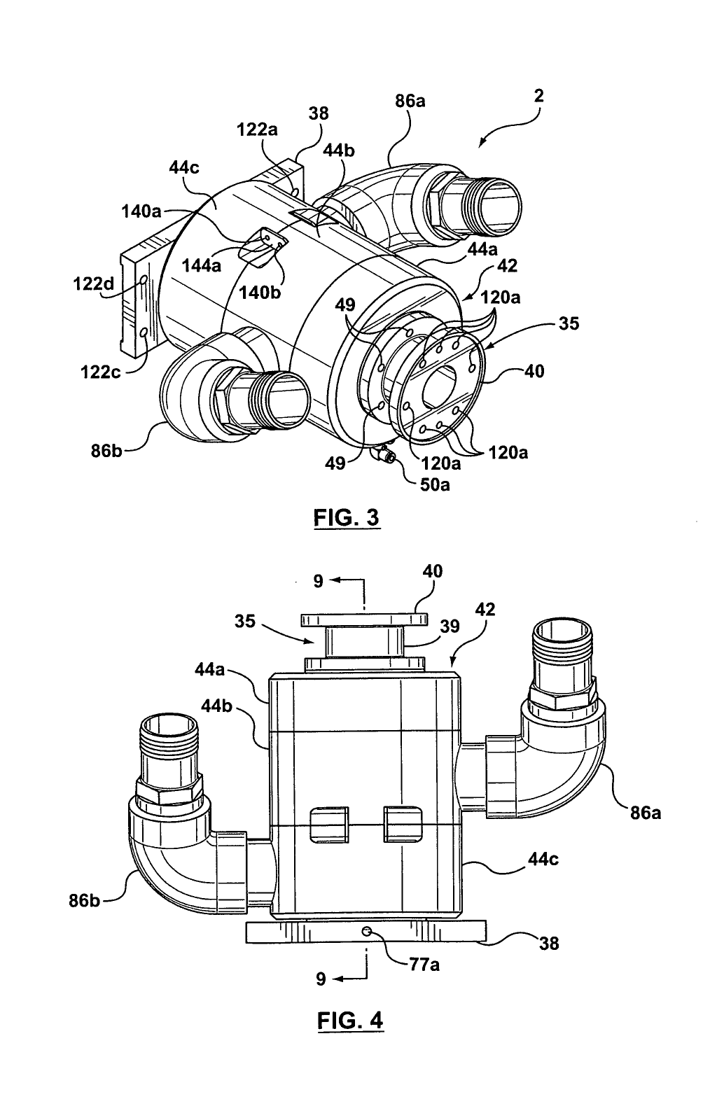

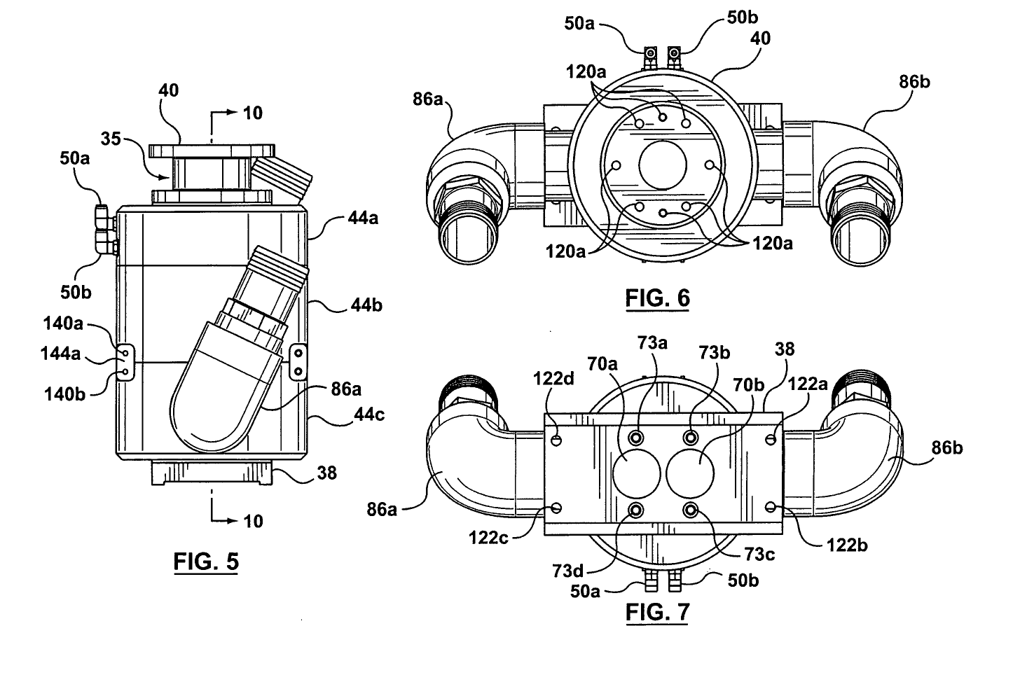

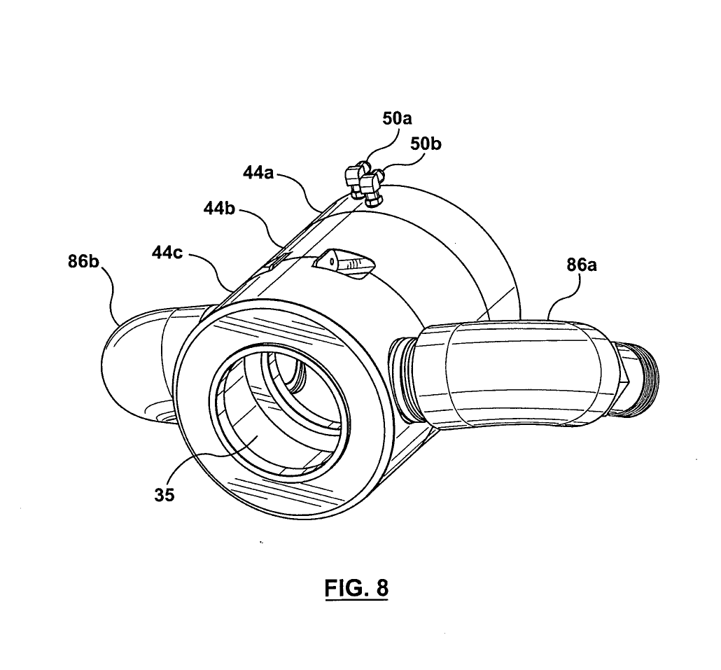

With reference to FIGS. 2 to 8, rotary union connector 27 is illustrated in detail. The components of the rotary union connector 27 can be made from any suitable material. To minimize the weight of the rotary union connector 27 (which is a design consideration in robot arms with end effectors) at least some of the components may be made from suitable lightweight materials including UHMW, Polypropylene to name a few, and including suitable hard or engineered plastics like extruded and cast nylons such as for example NYLATRON™ made by Quadrant Engineering Plastics Products. In particular, outer housing 42 of rotary union connector 27 as well as vacuum connectors 86a, 86b can be made from such lightweight but strong materials.

Outer housing 42 includes an outer air chamber 44a, primary outer vacuum chamber 44b, and secondary outer vacuum chamber 44c, which are fixedly interconnected to each other in a stacked arrangement. One or more of these components can be made from a suitable selected lightweight material. This allows for a relatively large sized outer housing 42 permitting relatively large inner vacuum channels, to be made which does not have unnecessary additional weight.

Rotary union connector 27 also may have an inner cylinder 35, which may include a cylinder head member 39, a pressurized air manifold 36a, a vacuum manifold 36b, and end effector mounting plate 38. Each of these components may be also interconnected in a stacked arrangement. As these components may be directly connected to the arm section 15 and end effector 30, and carry significant loads, particularly during operation, they may be made from a material which is stronger than the material from which the components of outer housing 42 are made. Examples of the materials from which one or more of the components of inner cylinder 35 may be made from metals, including steel, stainless steel, aluminum, as well as other suitable materials. These materials may also be relatively heavy (i.e. having a higher density) compared to the materials from which the outer housing 42 is made.

Thus, different materials may be selected for outer housing 42 compared to inner cylinder 35 to satisfy the overall design requirements/constraints.

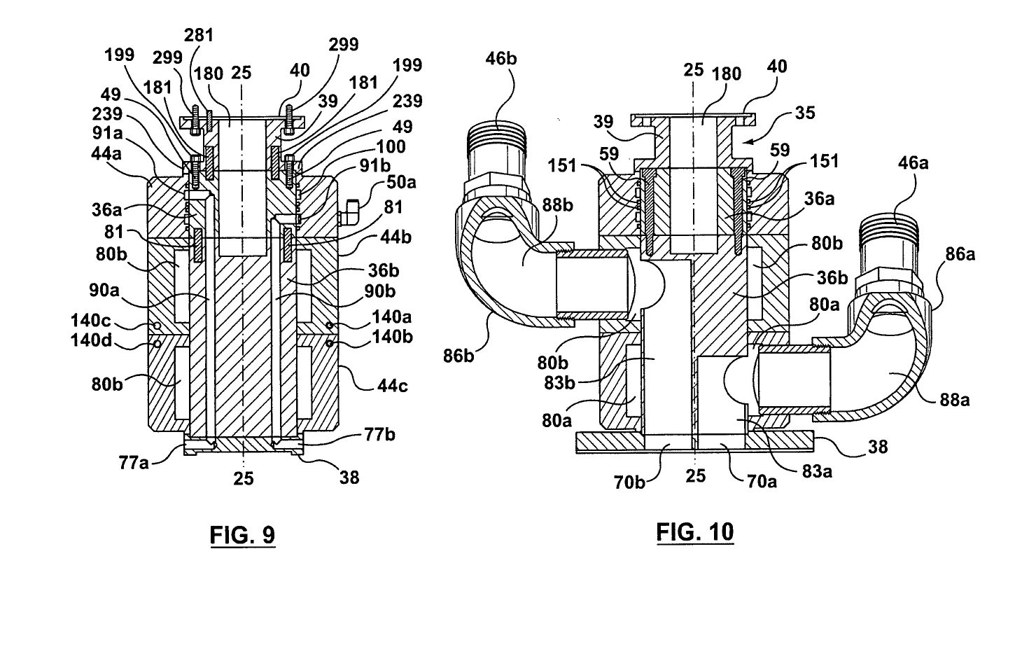

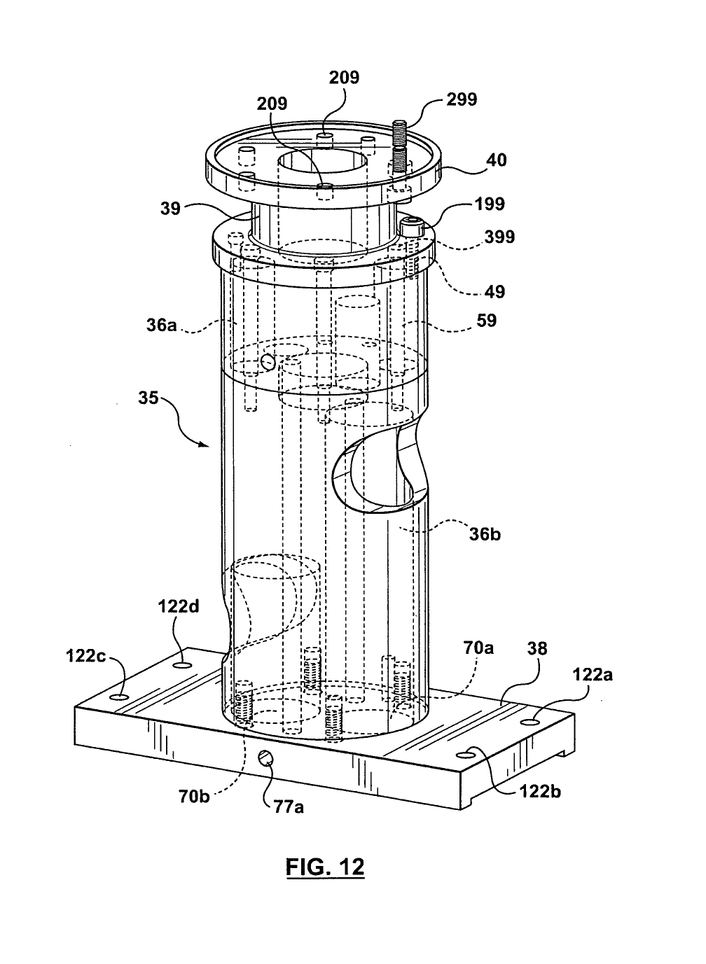

As is illustrated in more detail in FIGS. 9, 10, 11 and 12, the rotary union connector 27 is configured such that outer housing 42 and inner cylinder 35 can rotate relative to each other, the inner cylinder 35 being mounted inside the outer housing 42, about a common longitudinal axis that is aligned with axis 25. However, it will be appreciated that the outer housing 42 may not rotate about axis 25 relative to arm section members 35; instead the inner cylinder 35 will rotate within the outer housing 42. Additionally, by selecting materials such as for example NYLATRON™ for outer housing 42 and steel for inner cylinder 35, the inner cylinder may freely rotate within the outer housing 42 without the requirements for separate lubrication of the interface surfaces. A gap may be provided between the opposing cylindrical surfaces of outer housing 42 and inner cylinder 42. This gap may for example be between 0.005 and 0.010 inches.

Cylinder head member 39 may have a mounting plate 40, which may interconnect with flange drive plate 29 using bolts 299. Additional dowels 281 may be received into dowel holes 209 in plate 40 and corresponding holes in plate 29 to assist in providing additional rotational load bearing capacity and in alignment between the plates. Thus, when drive plate 29 is rotated by the drive motor 75 controlled by robot controller 100, inner cylinder 35 can rotate inside the outer housing 42.

As part of the stacked arrangement of inner cylinder 35, cylinder head member 39 may be fixedly connected to pressurized air manifold 36a with bolts 199 received in appropriate bolt holes 49, such that the head member 39 can be clamped onto the upper portion of pressurized air manifold 36a. Again, additional dowels 181 may be received into dowel holes in the mating surfaces of head member 39 and air manifold 36a to assist in providing additional rotational load bearing capacity and in alignment between the these members. A cylindrical slot 180 may be formed in cylindrical head member 39 to reduce the overall weight of the rotary union connector.

Similarly, pressurized air manifold 36a may be fixedly connected to vacuum manifold 36b by providing long bolts passing through corresponding bolt holes 59 (see FIG. 10) passing through vacuum manifold 36a into manifold 36b, to clamp the vacuum manifold 36a onto the upper portion of vacuum manifold 36b. Additional dowels 81 (see FIG. 9) may be received into dowel holes in the mating surfaces of vacuum manifold 36a and vacuum manifold 36b to assist in providing additional rotational load bearing capacity and in alignment between the these members.

With respect to housing 42, outer air chamber 44a is fixedly connected to primary outer vacuum chamber 44b by use of dowels received in dowel holes in the mating surfaces in chambers 44a and 44b. While there is relatively little rotational load passed between air chamber 44a and vacuum chamber 44b, the dowels that may be received into dowel holes in the mating surfaces of air chamber 44a and vacuum chamber 44b may assist in ensuring alignment between the these components.

Additionally a downward facing surface of a flange 239 of cylinder 39 may be employed to press down on a top surface portion of air chamber 44a, to ensure that the outer housing 42 is securely held between bottom mounting plate 38 and cylinder head 39. However, there will not be so great a force exerted between the opposed surfaces that the rotation of cylinder 35 within the outer housing will be prevented.

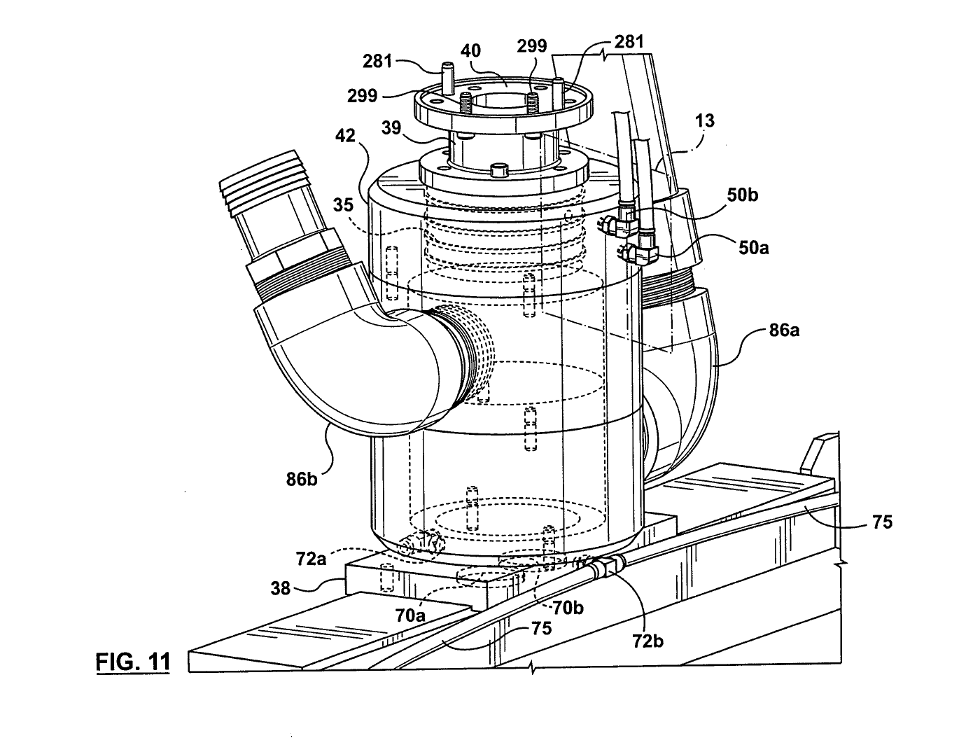

Primary vacuum chamber 44b may be mounted on secondary vacuum chamber 44c in any suitable manner. As in the example embodiment illustrated in the Figs., two notches at the bottom of primary vacuum chamber 44b may be aligned with the corresponding two notches at the top of secondary vacuum chamber 44c. Two plates 144a and 144b may then be placed over bolt or screw holes 140a, 140b, 140c, and 140d. A long bolt or screw may then be inserted into the top shaft bounded by hole 140a and hole 140c. A second screw or bolt may be inserted similarly into the bottom shaft. An identical connection mechanism may be located on the opposite side of vacuum chambers 44b and 44c. Additional dowels may be received into dowel holes in the mating surfaces of vacuum chamber 44b and vacuum chamber 44c to assist in providing some assistance in ensuring alignment between the these components (see FIG. 11).

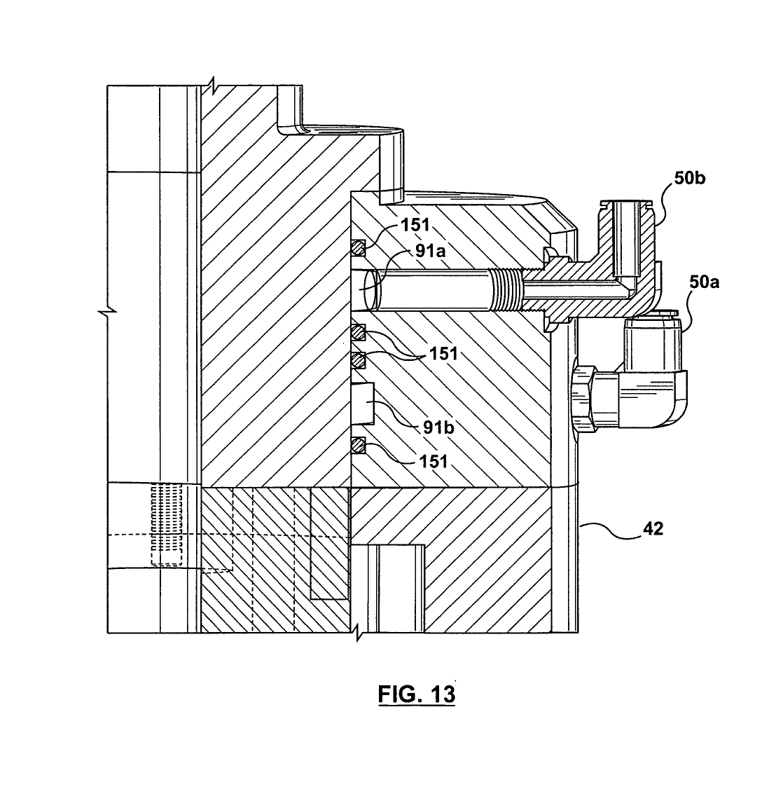

Additionally, and as shown in detail in FIG. 13, the interfaces between robot mount 40a, air chamber 44a, primary vacuum chamber 44b and secondary vacuum chamber 44c are sealed in a conventional way, for instance, using O-rings 151 so as to preserve vacuum and pressurized air forces in 44a, 44b, and 44c. Each chamber 44a, 44b and 44c is self-contained and sealed relative to one another. That is, a pressurized air may exist in chamber 44a simultaneously with air under negative pressure in 44b or 44c.

Bottom plate 38 may also connected to the bottom surface of cylinder 35 by providing a slight recess for the cylinder to fit into, and may also include bolts 73a-d which pass up through the plate 38 into the bottom surface of vacuum manifold 36b. Dowels received in mating dowel holes in the adjacent surfaces on the plate 38 and manifold 36b may also be provided.

Vacuum hose 99a may be attached to vacuum connector 86a in a conventional way, for example, by securing on notches 46a with a straps (not shown). A secondary vacuum hose 99b may be similarly attached to vacuum connector 86b such as securing on notches 46b with a strap. The vacuum hoses 99a, 99b may follow a path from the connectors 86a, 86b to arm section 15 on to arm section 16 where they then join at T-connector 105. Main hose 107 then is connected to the vacuum source (not shown).

Pressurized air hoses (not shown) are in connected to air inlet connectors 50a, 50b which are in communication with channels in pressurized air chamber 44a. A channel can thus be provided as the hoses may follow a path from the connectors 50a, 50b to arm section 15 or to arm section 16 where they are then fed into the inner housing or chamber of arm section 15 or 16 and can then progress through the articulated arm sections or the robotic arm, to the source of pressurized air which may also be proximate the base 20 of robot 11.

Turning in particular to FIG. 11, plate 38 has pressurized air channel outlets 77a, 77b each of which may have a T-connector 72a, 72b. The outlets of T-connectors 72a, 72b are connected to hoses 75. These air hoses may be interconnected to pneumatic cylinders mounted on the end effector. The pneumatic cylinders can be used to adjust the position/pitch of the pick up members 32.

With reference now to specifically FIGS. 9 and 10, vacuum chamber 44b has a continuous cylindrical channel 83a formed therein. Vacuum connector 86a has a channel 88a that is in communication with channel 80a. Vacuum channel 80a is in continuous communication with the inlet to a vacuum channel 86a which runs axially through part of vacuum manifold 36b and communicates vacuum to vacuum opening 70a.

Likewise vacuum chamber 44c has a continuous axial cylindrical channel 80b formed therein. Vacuum connector 86b has a channel 88b that may be in communication with channel 80b. Vacuum channel 80b is in continuous communication with a vacuum channel 86b which may also run axially through vacuum manifold 36b, parallel to channel 86a, and may communicate vacuum to vacuum opening 70b. Each of the vacuum channels which pass through the vacuum chambers 44b, 44c, and vacuum manifold 36b may have a cross sectional diameter that is in the range of about 1.5 to about 2.5 inches.

The foregoing vacuum channels through cylinder 35 and housing 42 provide a communication of vacuum from the vacuum connectors 86a, 86b to the end effector 30.

Air inlet connectors 50a and 50b have channels, which are in communication air channels 91a, 91b formed in pressurized air manifold 44a. Air channels 91a, 91b are in continuous communication with the inlet to a pressurized air channel 90a, 90b respectively. Each air channel 90a, 90b runs axially through air manifold 36a and through vacuum manifold 36b, parallel to channels 86a and 86b, but each being spaced from each other. Air channels 90a, 90b thus run axially and the as shown in FIG. 9, have a 90 degree turn to terminate at air outlets 72a, 72b in plate 38 (FIGS. 9, 11 and 12). The air channels 90a 90b may typically have cross sections in the range of about 0.25 to about 0.5 inches.

In operation, controller 100 moves robotic arm 10 through movement of the articulated arm sections 15, 17 and 18. At a particular time, controller 100 may also cause drive plate 29 of drive motor 75 to rotate as well about axis 25 in either or both directions. Drive plate 29 is attached to mounting plate 49 on inner cylinder 35. Thus inner cylinder 35 will also rotate. Since end effector 30 is fixedly connected at the bottom of inner cylinder 35, it will also rotate. Housing 42 will not, however, receive any significant rotational load and thus will remain substantially stationary relative to the arm section 15.

When pressurized air is supplied through air inlets 50a and 50b, a pressurized air force is created in air chamber 44a. Pressurized air is then forced down through air channels 90a and 90b to air outlets 72a, 72b. Since both air channels 90a and 90b are in communication with air chamber 44a at all times, inner cylinder 35 may rotate while housing 42 remains stationary without interruption to the supply of the pressurized air.

Application of a vacuum flow works in a similar but reverse manner to the pressurized air. As suction is applied by the vacuum source, vacuum flow is drawn through vacuum channel 88a, and a vacuum air flow is created in vacuum channel 80a. Since vacuum channel 80a is also in communication with vacuum channel 86a, the vacuum flow is drawn through channel 86a from vacuum outlet 70a. The vacuum flow may remain uninterrupted when inner cylinder 35 rotates because vacuum channel 86a may be in communication with vacuum channel 80a at all times.

The secondary vacuum flow operates in a similar manner to the primary vacuum flow. As suction is applied by the vacuum source, vacuum flow is drawn through vacuum channel 88b, and a vacuum air flow is created in vacuum channel 80. Since vacuum channel 80b is also in communication with vacuum channel 86b, the vacuum flow is drawn through channel 86b from vacuum outlet 70b. The vacuum flow may remain uninterrupted when inner cylinder 35 rotates because vacuum channel 86b may be in communication with vacuum channel 80b at all times.

Since housing 42 may remain stationary, the pressurized air lines and vacuum hoses do not need to rotate, and hence they do not restrict the range of rotation of end effector 30 about axis 25.

Other embodiments of the present invention are possible and will be apparent to those skilled in the art. By way of example only, only one vacuum chamber may be provided with one corresponding vacuum manifold, along with related vacuum channels. Also, the particular stacking arrangement of the vacuum chambers and the air chamber, and corresponding positions of the vacuum and air manifolds in the inner cylinder can also be altered. Also, by way of further examples only, additional chambers may be mounted on the rotary union connector to provide additional supply lines. The example embodiment described herein has two sources of pressurized air and two vacuum sources. However, it may be possible to add additional vacuum sources by mounting additional vacuum chambers onto the present three chambers and modifying the internal cylinder accordingly. Additional sources of pressurized air may also be provided in a similar fashion.

In this document the use of the term “including” means “including without limitation” and is not to be construed to limit any general statement which it follows to the specific or similar items or matters immediately following it.

It will be further understood that the invention is not limited to the embodiments described and shown herein, which are deemed to be merely illustrative of the best modes of carrying out the invention, and which are susceptible to modification or form, size, arrangement of parts and details of operation. The invention, rather, is intended to encompass all such modifications which are within its spirit and scope as defined by the claims.

We claim:

1. A rotary union connector for use with a robot arm, said robot arm having a drive member mounted to an arm section for rotation of said drive member relative to said arm section about an axis; said connector comprising:
(a) an outer housing;
(b) an inner cylinder fixedly mounted proximate a first end to said drive member and for rotation with said drive member arm about a central longitudinal axis of said inner cylinder that is aligned with said axis, said inner cylinder being mounted for rotation within and relative to said outer housing;
said inner cylinder having a first vacuum manifold with a first vacuum channel, and said inner cylinder being adapted to be fixedly mounted proximate a second end opposite to said first end, to an end effector, said end effector having a plurality of pick up members each having at least one suction cup;
said outer housing being disposed between said first and second ends of said inner cylinder and said outer housing comprising a first vacuum chamber having a first vacuum channel, and a vacuum opening for connection to a vacuum supply line to supply vacuum to said first vacuum channel in said vacuum chamber, said first vacuum channel of said vacuum chamber also being in continuous vacuum communication with said first vacuum channel of said vacuum manifold;
said first vacuum channel in said vacuum manifold having an opening for communicating vacuum from said opening to said at least one suction cup of said plurality of pick up members;
wherein when said drive member is rotated about said axis, said inner cylinder and said end effector will also rotate about said axis, with said outer housing remaining substantially stationary in rotational movement about said axis.

2. A connector as claimed in claim 1 wherein said inner cylinder has a second vacuum manifold with a second vacuum channel, and said outer housing comprises a second vacuum chamber having a second vacuum channel, and said outer housing comprises a second vacuum opening for connection to a vacuum supply line to supply vacuum to said second vacuum channel in said vacuum chamber, said second vacuum channel of said second vacuum chamber also being in continuous vacuum communication with said second vacuum channel in said vacuum manifold;
said second vacuum channel in said second vacuum manifold having a second opening for communicating vacuum from said second opening to at least one suction cup of said plurality of pick up members.

3. A connector as claimed in claim 2 wherein said second vacuum chamber is positioned axially adjacent said first vacuum chamber in a stacked arrangement.

4. A connector as claimed in claim 3 wherein said first vacuum channel in said first vacuum chamber is not in communication with said second vacuum channel of said second vacuum chamber.

5. A connector as claimed in claim 1 wherein said inner cylinder comprises an air manifold, and a first air channel having an opening in said air manifold, said first air channel for communicating pressurized air from said opening, through said air manifold to an air pressure outlet, and said outer housing comprises an air chamber having an air channel, and said air chamber comprises an opening for connection to a pressurized air supply line to supply pressurized air to said air channel in said air chamber, said air channel of said air chamber also being in continuous pressurized air communication with said air channel in said air manifold;
said air channel in said second air manifold having a second opening for communicating pressurized air from said second opening to said end effector.

6. A connector as claimed in claim 5 wherein said first air channel is adapted to communicate pressurized air from said opening through said air manifold and said vacuum manifold to an air pressure outlet.

7. A connector as claimed in claim 5 wherein said inner cylinder comprises a second air channel having an opening in said air manifold, said air channel for communicating pressurized air from said second opening, through said air manifold to a second air pressure outlet, and said air chamber comprises a second air channel, and said second air chamber comprises an second air opening for connection to a second pressurized air supply line to supply pressurized air to said second air channel in said air chamber, said second air channel of said air chamber also being in continuous pressurized air communication with said air channel in said air manifold;
said second air channel in said second air manifold having a second opening for communicating pressurized air from said second opening to said end effector.

8. A connector as claimed in claim 7 wherein said first air channel is adapted to communicate pressurized air from said opening through said air manifold and said vacuum manifold to an air pressure outlet, wherein said first air channel is adapted to communicate pressurized air from said opening through said air manifold and said vacuum manifold to an air pressure outlet.

9. A connector as claimed in claim 1 wherein said outer housing is made substantially from a material selected from UHMW, Polypropylene or an engineered plastic and said inner cylinder is made substantially from a material selected from steel, stainless steel or aluminum.

10. A connector as claimed in claim 9 wherein said engineered plastic is an extruded or cast nylon.

11. A connector as claimed in claim 1 wherein said outer housing is made substantially from a plastic and said inner cylinder is made substantially from a material selected from a metal.

12. A connector as claimed in claim 1 wherein said outer housing is made substantially from an engineered nylon and said inner cylinder is made substantially from a material selected from steel.

13. A connector as claimed in claim 1 wherein said outer housing is made substantially from a material selected having a substantially lower density than a material from which said inner cylinder is made.

14. A robot comprising:
(a) a base;
(b) an articulated arm comprising a plurality of arm sections, said arm sections comprising a distal arm section;
(c) a drive member mounted to said arm section and operable to rotate said drive member relative to said distal arm section about an axis;
(d) an end effector comprising a pick up member with a suction cup;
(e) a rotary union connector disposed between said drive member and said end effector, said connector comprising:
i. an outer housing;
ii. an inner cylinder fixedly mounted proximate a first end to said drive member for rotation with said drive member about a central longitudinal axis of said inner cylinder that is aligned with said axis, said inner cylinder being mounted for rotation within and relative to said outer housing;
iii. said inner cylinder having a first vacuum channel, and said inner cylinder being adapted to be fixedly mounted proximate a second end opposite to said first end, to said end effector;
iv. said outer housing being disposed between said first and second ends of said inner cylinder and said outer housing comprising a first vacuum channel and a vacuum opening for connection to a vacuum supply line to supply vacuum to said first vacuum channel, said first vacuum channel also being in continuous vacuum communication with said first vacuum channel in said inner cylinder;
v. said first vacuum channel having an opening for communicating vacuum from said opening to said suction cup;
wherein when said drive member is rotated about said axis, said inner cylinder and said end effector will also rotate about said axis, with said outer housing remaining substantially stationary in rotational movement about said axis.

15. A robot as claimed in claim 14 wherein:
said first vacuum channel in said outer housing is formed in a first vacuum chamber; and
said first vacuum channel in said inner cylinder is formed at least in part in a first vacuum manifold.

16. A connector as claimed in claim 15 wherein said inner cylinder has a second vacuum manifold with a second vacuum channel, and said outer housing comprises a second vacuum chamber having a second vacuum channel, and said outer housing comprises a second vacuum opening for connection to a vacuum supply line to supply vacuum to said second vacuum channel in said vacuum chamber, said second vacuum channel of said second vacuum chamber also being in continuous vacuum communication with said second vacuum channel in said vacuum manifold;
said second vacuum channel in said second vacuum manifold having a second opening for communicating vacuum from said second opening to at least one suction cup of said plurality of pick up members.

17. A connector as claimed in claim 16 wherein said second vacuum chamber is positioned axially adjacent said first vacuum chamber is a stacked arrangement.

18. A connector as claimed in claim 17 wherein said first vacuum channel in said first vacuum chamber is not in communication with said second vacuum channel of said second vacuum chamber.

19. A connector as claimed in claim 15 wherein said inner cylinder comprises an air manifold, and a first air channel having an opening in said air manifold, said air channel for communicating pressurized air from said opening, through said air manifold and said vacuum manifold to an air pressure outlet, and said outer housing comprises an air chamber having an air channel, and said air chamber comprises an opening for connection to a pressurized air supply line to supply pressurized air to said air channel in said air chamber, said air channel of said air chamber also being in continuous pressurized air communication with said air channel in said air manifold;
said air channel in said second air manifold having a second opening for communicating pressurized air from said second opening to said end effector.

20. A connector as claimed in claim 19 wherein said second vacuum chamber is positioned axially adjacent said first vacuum chamber, and said air chamber is positioned axially adjacent said first vacuum chamber in a stacked arrangement.

21. A connector as claimed in claim 19 wherein said first and second vacuum chambers and said air chamber are positioned axially in a stacked arrangement.

22. A connector as claimed in claim 19 wherein said inner cylinder comprises a second air channel having an opening in said air manifold, said air channel for communicating pressurized air from said second opening, through said air manifold and said vacuum manifold to a second air pressure outlet, and said air chamber comprises a second air channel, and said second air chamber comprises an second air opening for connection to a second pressurized air supply line to supply pressurized air to said second air channel in said air chamber, said second air channel of said air chamber also being in continuous pressurized air communication with said air channel in said air manifold;
said second air channel in said second air manifold having a second opening for communicating pressurized air from said second opening to said end effector.

23. A connector as claimed in claim 14 wherein said outer housing is made substantially from a material selected from UHMW, Polypropylene or an engineered plastic and said inner cylinder is made substantially from a material selected from steel, stainless steel or aluminum.

24. A connector as claimed in claim 23 wherein said engineered plastic is an extruded or cast nylon.

25. A connector as claimed in claim 14 wherein said outer housing is made substantially from a plastic and said inner cylinder is made substantially from a material selected from a metal.

26. A connector as claimed in claim 14 wherein said outer housing is made substantially from an engineered nylon and said inner cylinder is made substantially from a material selected from steel.

27. A connector as claimed in claim 14 wherein said outer housing is made substantially from a material selected having a substantially lower density than a material from which said inner cylinder is made.

28. A rotary union connector for use with a robot arm, said robot arm having a drive member mounted for rotation, said connector comprises:
(a) an outer housing;
(b) an inner cylinder fixedly mounted proximate a first end for rotation with said drive member for rotation of said inner cylinder about a central longitudinal axis of said inner cylinder, said inner cylinder being mounted for rotation within and relative to said outer housing; said inner cylinder having a first vacuum channel, and said inner cylinder being adapted to be fixedly mounted to an end effector, said end effector having a pick up member having at least one suction cup;
said outer housing comprising a first vacuum channel and a first vacuum opening for connection to a vacuum supply line to supply vacuum to said first vacuum channel in said outer housing, said vacuum channel in said outer housing also being in vacuum communication with said first vacuum channel in said inner cylinder;
said first vacuum channel in said inner cylinder having an opening for communicating vacuum from said opening to said at least one suction cup of said pick up member;
wherein when said drive member is rotated, said inner cylinder and said end effector will rotate about said axis, with said outer housing remaining substantially stationary in rotational movement about said axis.
